(19) United States
(12) Patent Application Publication
(10) Pub. No.: US 2017/0148415 A1
(43) Pub. Date: May 25, 2017

(54) VEHICULAR APPARATUS

(71) Applicant: DENSO CORPORATION, Kariya-city, Aichi-pref. (JP)

(72) Inventor: Nobuhiro OGURA, Kariya-city (JP)

(21) Appl. No.: 15/327,053

(22) PCT Filed: Oct. 29, 2015
(86) PCT No.: PCT/JP2015/005442

§ 371 Date: Jan. 18, 2017

(30) Foreign Application Priority Data
Nov. 4, 2014 (JP) 2014-224215

(51) Int. Cl. G09G 5/00; G06F 3/02; G06F 3/041; B60K 37/02; B60R 1/00

(52) U.S. Cl. CPC G09G 5/006; B60K 37/02; B60R 1/00; G06F 3/041; G06F 3/02; B60K 2350/1028; B60K 2350/106; B60K 2350/2013; B60K 2350/352; B60R 2300/802; B60R 2300/207; G09G 2330/026; G09G 2354/00; G09G 2380/10

(57) ABSTRACT

A vehicular apparatus transitions from a system sleep state that causes a first controller and a second controller to be each under sleep state into a waiting state that waits to receive a specified kind of data when the first controller is activated. When receiving the specified kind of data before a waiting time elapses under the waiting state, the waiting state transitions into a preparing state that waits to receive an activation manipulation on condition that reading out a program and developing the program into a memory have been completed by the second controller being activated. When receiving the activation manipulation before a manipulation waiting time elapses under the preparing state, the preparing state transitions into an executing state that executes the program developed in the memory with the second controller.

### CROSS REFERENCE TO RELATED APPLICATION

The present application is based on Japanese Patent Application No. 2014-224215 filed on Nov. 4, 2014, the disclosure of which is incorporated herein by reference.

### TECHNICAL FIELD

The present disclosure relates to a vehicular apparatus mounted in a vehicle.

### BACKGROUND ART

Various kinds of apparatuses mounted in a vehicle mainly operate with supply of electric power from a battery. Supplying constantly the electric power to each apparatus poses a significant power consumption in the battery. To reduce such power consumption in the battery, the supply of the electric power is stopped to part of the apparatuses when the accessory electric power source (hereinafter, ACC switch) turns off. The vehicular apparatuses, which the supply of the electric power is stopped to, start to operate by a user performing an activation manipulation such as turning on the ACC switch.

Now, as apparatuses recently provide more advanced functions, the magnitude or the number of programs that are to be read out at activation is increased. This lengthens the time needed for starting to provide functions following an activation manipulation by a user; such time may be hereinafter referred to as an activation time for each vehicular apparatus, for convenience. Patent literature 1, for instance, proposes a configuration containing two control circuits (controllers) having different activation times such as main CPU and subordinate CPU so as to achieve a prompt screen-view display control by permitting the subordinate CPU to control display from the time the ACC switch is turned on to the time the main CPU is activated completely.

### PRIOR ART LITERATURES

### Patent Literature

Patent literature 1: JP 2009-284023 A

### SUMMARY OF INVENTION

Even such configuration in Patent literature 1 cannot shorten an activation time for each apparatus than that of a controller such as CPU. That is, a conventional configuration has a limitation in shortening an activation time for each vehicular apparatus.

It is an object of the present disclosure to provide a vehicular apparatus that can shorten a period of time from when a user inputs an activation manipulation to when functions can be provided.

According to an example of the present disclosure, a vehicular apparatus is provided as follows. The vehicular apparatus transitions, when a first controller is activated, from a system sleep state that causes the first controller and a second controller to be each under sleep state into a waiting state that waits to receive a predetermined specified kind of data. The vehicular apparatus transitions, when receiving the specified kind of data before a reception waiting time elapses under the waiting state, from the waiting state to a preparing state, the preparing state that waits to receive an activation manipulation on condition that the second controller being activated has completed reading out a program and developing the program in a memory. The vehicular apparatus transitions, when receiving the activation manipulation before a manipulation waiting time elapses under the preparing state, from the preparing state into an executing state that executes the program developed in the memory with the second controller.

The above configuration activates or starts a preparation to provide a function based on as a trigger a fact that data flows on an in-vehicle network. The configuration can complete the reading of a program and developing the program into the memory before the user performs an activation manipulation (e.g., turning on the ACC switch). The configuration can thus significantly shorten a period of time from when the ACC switch is turned on to when a function is started to be provided, i.e., the activation time of a vehicular apparatus actually felt by the user.

### BRIEF DESCRIPTION OF DRAWINGS

The above and other objects, features and advantages of the present disclosure will become more apparent from the following detailed description made with reference to the accompanying drawings. In the drawings:

FIG. 1 is a diagram schematically illustrating an electrical configuration of a vehicular apparatus according to an embodiment of the present disclosure;

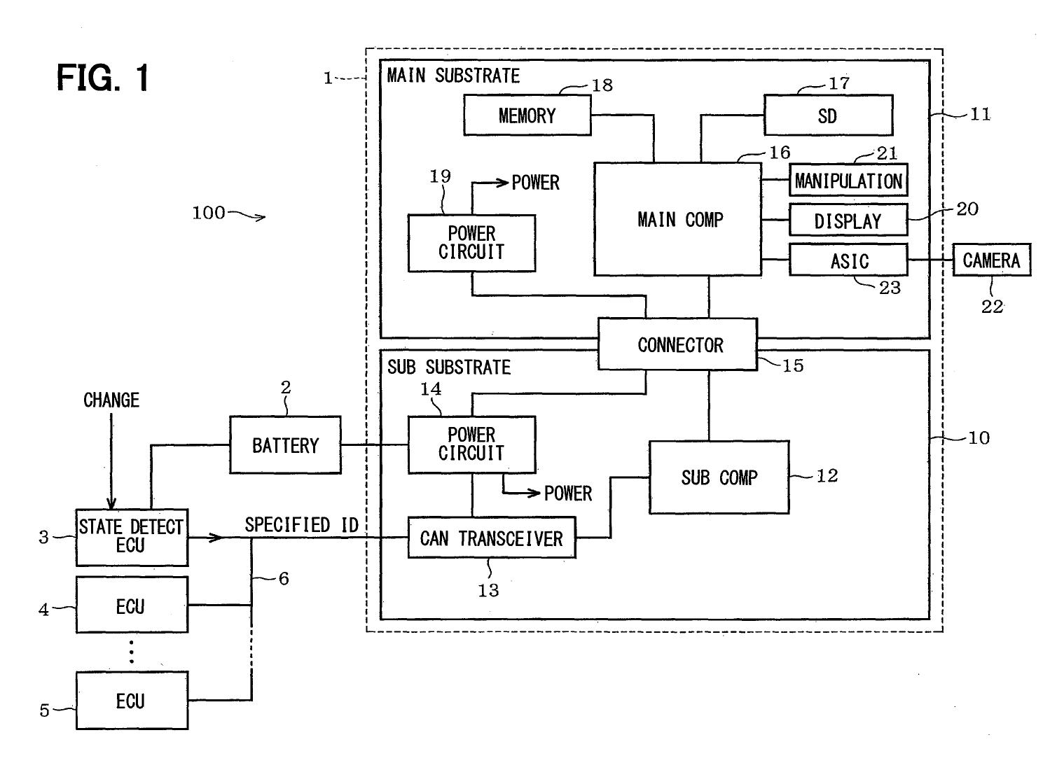

FIG. 2 is a diagram schematically illustrating transitions of states of the vehicular apparatus;

FIG. 3A is a diagram schematically illustrating an activation time of the vehicular apparatus; and

FIG. 3B is a diagram schematically illustrating a reference example of an activation time of a vehicular apparatus.

### EMBODIMENTS FOR CARRYING OUT INVENTION

An embodiment of the present disclosure will be explained with reference to drawings.

A vehicular apparatus 1 is mounted in a vehicle (unshown) and supplied with electric power from a battery 2. In addition to the vehicular apparatus 1, the vehicle is provided with a state detection ECU 3 (Electronic Control Unit) and ECUs 4 and 5. These units are connected to communicate with each other using a CAN bus 6 (Controller Area Network “registered trademark”) corresponding to an in-vehicle network. Note that the vehicular apparatus 1 may be mounted to the vehicle, fixedly or detachably. The vehicular apparatus 1, state detection ECU 3, and ECUs 4 and 5 are connected to each other via the CAN bus 6, so as to be included in an in-vehicle system 100.

The vehicular apparatus 1 includes a subordinate substrate 10 and a main substrate 11. The subordinate substrate 10 is connected with the main substrate 11 via a connector 15 to communicate and supply electric power with each other. Furthermore, the subordinate substrate 10 and the main substrate 11 may not be necessarily provided as separate two substrates, but may be provided as a single substrate. Providing two separate substrates enables a configuration where a single common subordinate substrate 10 is paired with one of several main substrates 11, which are replaceable mutually depending on required functions.

The subordinate substrate 10 is mounted with a subordinate computer 12, which may be referred to as a first controller or first control circuit, a CAN transceiver 13 that is equivalent to a monitor, and a subordinate power circuit 14. The subordinate computer 12 includes a microcomputer containing a CPU, ROM, RAM (none shown) and operates with the electric power from the subordinate power circuit 14. The subordinate computer 12 acquires a data frame received by the CAN transceiver 13. The data frame of CAN contains an identifier (ID) and a data field; other details are omitted from the explanation since those are commonly known.

In addition, the subordinate computer 12 under a power saving mode (i.e., sleep state) is activated by the CAN transceiver 13; the power saving mode consumes electric power smaller than that of a normal operation. That is, the CAN transceiver 13 is supplied constantly with electric power from the subordinate power circuit 14, and monitors the fluctuation of the CAN bus 6, i.e., monitoring whether data flows on the CAN bus 6; when detecting that the data flows on the CAN bus 6, the CAN transceiver 13 receives the data and hands over it to the subordinate computer 12.

Such handing over the data from the CAN transceiver 13 to the subordinate computer 12 results in inputting a signal from the CAN transceiver 13 to the subordinate computer 12, thereby activating the subordinate computer 12 currently under the sleep state. Note that when the subordinate computer 12 has been already activated, the data is handed over to the subordinate computer 12 without the above procedure.

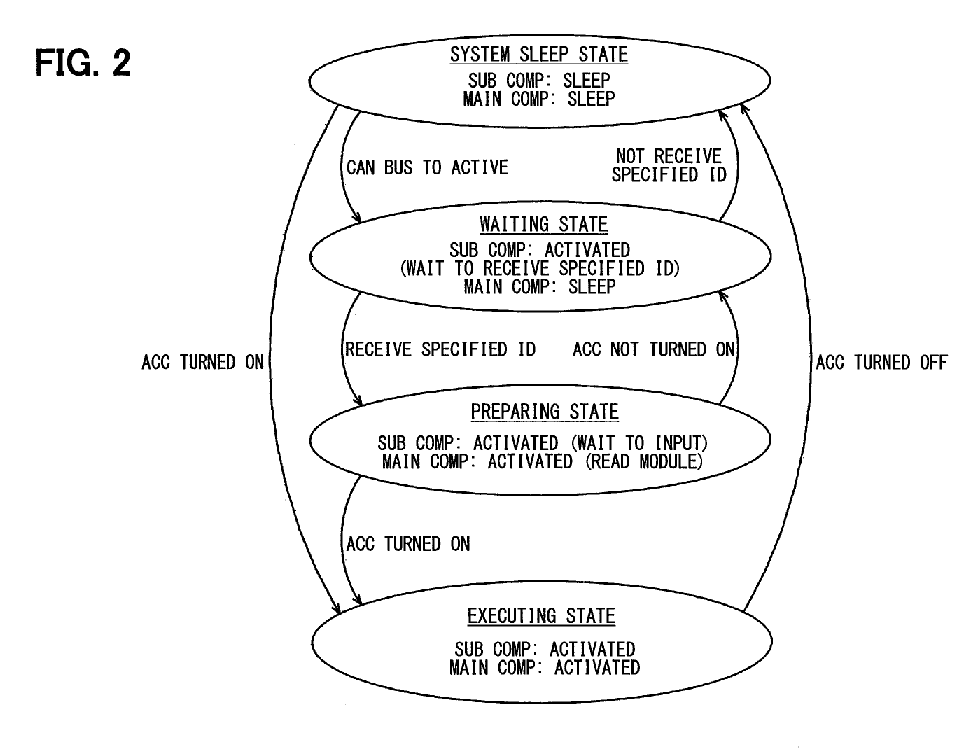

In addition, the subordinate computer 12 has a function that controls transitions of operating states (refer to FIG. 2) of the vehicular apparatus 1. The subordinate computer 12 performs the control of start of the electric power supply to the main substrate 11, or the output of an operation instruction to the main computer 16 (e.g., transition instruction from a preparing state to an executing state in FIG. 2); the detail of the control will be explained later.

The main computer 16, which may be referred to as a second controller or a second control circuit, is provided in the main substrate 11. The main computer 16 is a controller mainly executing functions that the vehicular apparatus 1 provides. The main computer 16 includes a microcomputer containing a CPU, ROM, RAM (none shown) and operates with the electric power from the main power circuit 19. The main computer 16 executes a program stored in a SD 17 (Secure Digital, equivalent to a storage) formed of a semiconductor memory. Specifically, at the time of activation, the main computer 16 reads programs from the SD 17, develops the read programs into the main memory 18 formed of DDR memory etc., and executes the developed programs, thereby providing functions of the vehicular apparatus 1.

The main power circuit 19 supplies the electric power, which is supplied from the subordinate substrate 10, to each circuit in the main substrate 11. At this time, the main power circuit 19 starts the supply of the electric power based on an activation instruction from the subordinate computer 12. The main power circuit 19 serves also as a reset circuit of the main computer 16. In addition, the main power circuit 19 has a function to adjust the electric power depending on a loaded condition of the main computer 16. Specifically, when determining that the main computer 16 is under a low loaded state, the main power circuit 19 reduces the electric power so as to prioritize power saving. When determining that the main computer 16 is under a high loaded state, the main power circuit 19 increases the operating power supplied to the main computer 16 to prioritize a processing speed.

The main substrate 11 is provided with a display unit 20 and a manipulation unit 21. The display unit 20 includes a liquid crystal display and is provided in a dashboard of the vehicle. The manipulation unit 21 includes a touch panel (unshown) and a mechanical switch (unshown), which are provided to cooperate with the display unit 20, to receive a manipulation by a user.

The vehicular apparatus 1 has a function to provide the user with various kinds of information visually. Note that “information” is used not only as being uncountable but also as being countable, and is used as being equivalent to an “information item.” Specifically, the vehicular apparatus 1 has a function to provide a user with images or videos of an area behind the vehicle. That is, a camera 22 as an imaging unit captures an image of a dead zone for a user, in particular, for a driver, such as an area behind the vehicle or an area adjacent to the side of the vehicle; the captured image is processed with ASIC 23 (Application Specific Integrated Circuit) for image processing; and the processed image is displayed on the display unit 20 by being accompanied with marking indicating a vehicle width superimposed, for instance. Further, functions provided by the vehicular apparatus 1 may include a navigation function, an audio function, or combination thereof.

The main computer 16 needs to read (i) an OS (Operating System) for realizing functions provided by the vehicular apparatus 1 or (ii) a relatively great magnitude of program such as image processing. In addition, the present embodiment needs to initialize the ASIC 23. This poses the main computer 16 to require a period of time for activation longer than that of the subordinate computer 12. Note that the navigation function, if provided by the vehicular apparatus 1, also needs to execute processes of generating a map screen-view from map data, or calculating a guidance route from link information; this poses the main computer 16 to need to read a relatively great magnitude of program, probably requiring a longer period of time for activation.

The following explains while referring to reading a program necessary for achieving a function provided by the vehicular apparatus 1 as reading of a module. Note that, as explained later, under the state where the reading of the module is completed, the function itself is not provided practically and any display is not shown on the display unit 20.

The following explains operations of the above configuration.

Suppose that the vehicular apparatus 1 provides an image of a dead zone like the present embodiment. In such cases, a period of time from when the ACC switch (accessory power source) is turned on to when the image is provided corresponds to a period of time from when a user starts to drive the vehicle to when the user is able to perform a safety check for an area behind the vehicle. As such period of time becomes shorter, a more significant contribution is expected for safety. In addition, suppose that the vehicular apparatus 1 provides a navigation function. Even in such cases, if a period of time from when the ACC switch is turned on to when an input of a destination is able to be accepted becomes shorter, a more significant contribution is expected for convenience.

In contrast, as described, when the magnitude or the number of kinds of programs that a controller such as the main computer 16 needs to read increases (i.e., when reading of the module takes time), enhancement of the safety or convenience may become more difficult.

Thus, the vehicular apparatus 1 according to the present embodiment shortens a period of time from when a user inputs an activation manipulation to when the corresponding function is ready to be provided; such period of time is referred to as an activation time of the vehicular apparatus 1, for convenience. Note that an activation time may be regarded as a period of time from when a user inputs an activation manipulation to when the function is ready to be practically used.

As in FIG. 2, the vehicular apparatus 1 has four operating states including a system sleep state, a waiting state, a preparing state, and an executing state. Note that the CAN transceiver 13 is always activated by being constantly supplied with electric power under all the four operating states.

First, the system sleep state is where the ACC switch is being turned off and both the subordinate computer 12 and the main computer 16 are under the sleep state. Note that, as above, even under the system sleep state, the CAN transceiver 13 is surely under an activated state, so as to monitor whether data flows on the CAN bus 6 using a hardware configuration. In the vehicular apparatus 1 under the system sleep state, the CAN transceiver 13 activates the subordinate computer 12 based on the fact that the CAN bus 6 becomes active (i.e., based on the fact that any data flows on the CAN bus 6), so that the vehicular apparatus 1 transitions from the system sleep state to the waiting state.

In the waiting state, the subordinate computer 12 is under activated state, whereas the main computer 16 is still under the sleep state. In the waiting state, the subordinate computer 12 stands by reception of a data frame with a specified ID (equivalent to specified kind of data). More specifically, the vehicular apparatus 1 causes the subordinate computer 12 to determine whether an ID of the received data frame of CAN is a predetermined specified ID.

The specified ID, which is predetermined in order to report that a change occurs in a vehicle state, is assigned to an ID of the data frame that is transmitted on the CAN bus 6 when the state detection ECU 3 detects the change in the vehicle state. Such change in the vehicle state includes a change according to a manipulation to the vehicle by the user, such as an opening of a door, a release of a door lock with a remote key, a brake manipulation, or turning on the ACC switch.

That is, the data frame with the specified ID flows on the CAN bus 6 at the time the user may start to drive the vehicle to start the travel such as the time the user opens a door of the vehicle under the halt state, or the user releases the lock of a door with a remote key. The data frame with the specified ID is notified uniformly even an apparatus under the sleep state, and is thus transmitted repeatedly to some extent.

The vehicular apparatus 1 under the waiting state therefore waits for the data frame with the specified ID while determining whether the time having elapsed since transitioning to the waiting state exceeds a reception waiting time that is predetermined. At this time, the subordinate computer 12 determines whether to perform a state transition only using the ID while not considering any data field of CAN. The reception waiting time may be varied as needed depending on specifications of the state detection ECU 3 or in-vehicle system 100.

The vehicular apparatus 1 transitions to the system sleep state when the reception waiting time elapses without receiving the data frame having the specified ID. That is, when any change in the vehicle state does not occur after the data flows on the CAN bus 6, the vehicular apparatus 1 transitions to the system sleep state after the reception waiting time elapses, so as to save the power consumption.

In contrast, when receiving the data frame with the specified ID before the reception waiting time elapses, the vehicular apparatus 1 transitions to the preparing state, where the main computer 16 is activated by the subordinate computer 12 and stands by under the state where the reading of the module has been completed, i.e., under the state where reading a program from the SD 17 and developing it into the main memory 18 are completed. In other words, the main computer 16 under the preparing state is ready to execute a program promptly after completing the read-out of the program that needs a relatively long time.

The vehicular apparatus 1 under the preparing state therefore waits for the ACC switch turning on (an activation manipulation by the user) while determining whether the time having elapsed since transitioning to the preparing state exceeds a manipulation waiting time that is predetermined. The manipulation waiting time may be varied as needed depending on specifications of the state detection ECU 3 or in-vehicle system 100.

The vehicular apparatus 1 transitions to the waiting state when the manipulation waiting time elapses without the ACC switch turned on. That is, when the ACC switch fails to turn on (i.e., the user does not indicate an intention to drive the vehicle) after the change in the vehicle state occurs, the vehicular apparatus 1 transitions to the waiting state after the manipulation waiting time elapses, so as to save the power consumption. Note that the fact that the ACC switch is turned on may be detected by receiving the data frame of CAN transmitted from the state detection ECU 3.

In contrast, the vehicular apparatus 1 transitions to the executing state when the ACC switch is turned on before the manipulation waiting time elapses. Under the executing state, the main computer 16 executes the program already developed in the main memory 18. This can execute the program without consuming any time for the reading of the module after the ACC switch is turned on, thus starting the provision of the function. That is, after the activation manipulation of turning on the ACC switch is performed, the provision of the function starts immediately. This enables the user to feel that the activation time for the vehicular apparatus 1 is overwhelmingly shortened, as compared with a conventional configuration that starts reading of a module after the ACC switch is turned on.

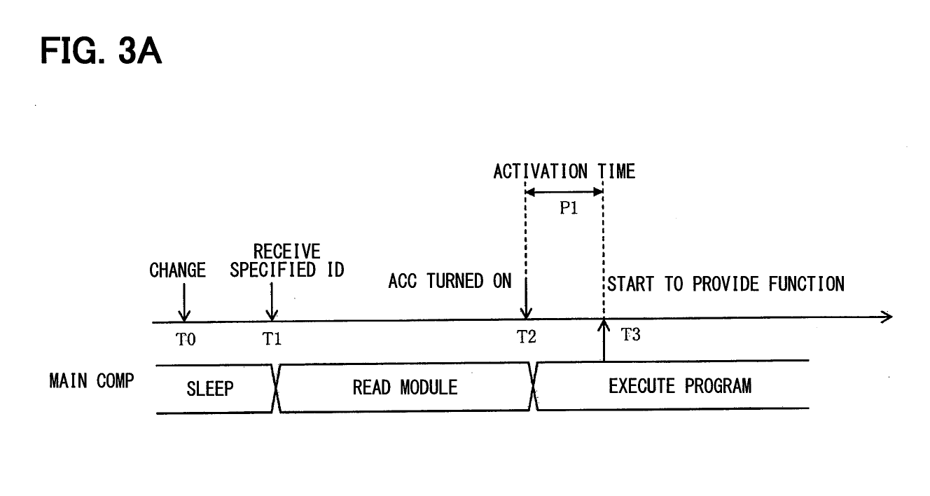

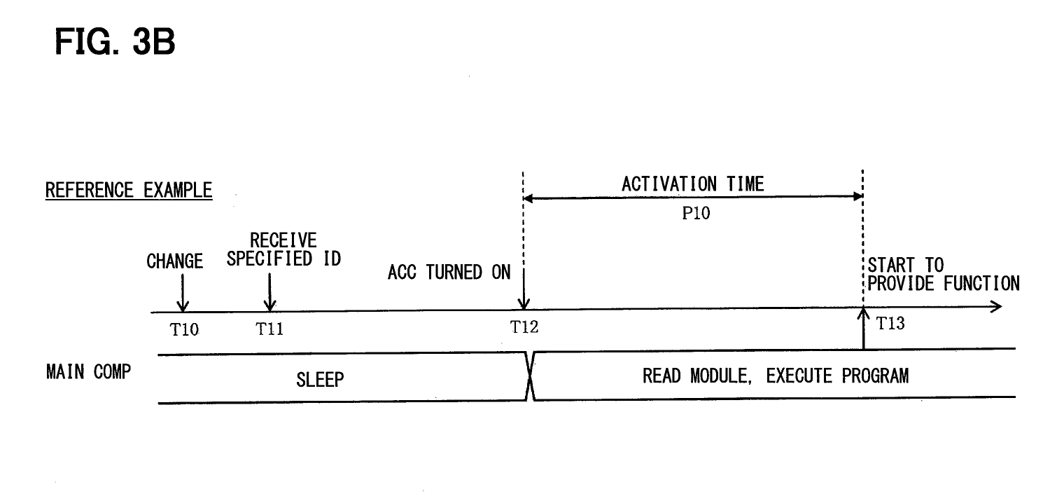

Specifically, referring to FIG. 3A, suppose that a change of a vehicle state that corresponds to releasing the lock occurs at the time T0. The change of the vehicle state is detected by the state detection ECU 3 while the vehicular apparatus 1 is notified with the data frame having the specified ID. Upon receiving the specified ID at the time T1, the vehicular apparatus 1 activates the main computer 16, starts reading of the module and waits for the ACC switch being turned on. That is, the vehicular apparatus 1 starts a preparation for providing a function based on as a trigger the reception of the specified ID.

When the ACC switch is then turned on at the time T2, the vehicular apparatus 1 permits the main computer 16 to start to execute the program and starts the provision of the function at the time T3. The function provided includes a screen-view display, for instance. The period of time P1 from the time T2 to the time T3 is equivalent to an activation time of the vehicular apparatus 1 that is felt actually by a user.

Here, the reading of the module has been already completed at the time T2. More specifically, the reading of the module is permitted to be started, with no user involvement, during a period of time from when a user releases the lock or opens a door to when the user sits on the seat and turns on the ACC switch. This makes the user feel that the provision of the function starts immediately after turning on the ACC switch.

Further, the vehicular apparatus 1 permits the function to be used immediately after the ACC switch is turned on, thereby displaying promptly an image captured by the camera 22 in the present embodiment to enable the prompt safety check at the time of starting to drive the vehicle. If a navigation function is provided, the designation of a destination is enabled just after the ACC switch is turned on, making the user feel convenient.

Further, the vehicular apparatus 1 is also enabled to start an activation after the ACC switch is turned on, as in FIG. 2. This supposes, for instance, the following situation: a user being located inside the vehicle waits for a friend to come and turns on the ACC switch when the friend comes.

In such situation, an activation is started after the ACC switch is turned on like in a conventional technique in FIG. 3B. Here, the activation time of the vehicular apparatus 1 is defined as a period of time P1 from the time T12 to the time T13, possibly becoming comparable with a conventional activation time. However, the user being inside of the vehicle is supposed to typically step on the brake pedal before turning on the ACC switch at the time of starting to drive the vehicle. Such stepping on the brake pedal corresponding to the change in the vehicle state becomes a trigger, permitting the activation to start at the time earlier than that as in FIG. 3B to possibly shorten the activation time of the vehicular apparatus 1.

The present embodiment may provide the following advantageous effects.

The vehicular apparatus 1 in a vehicle includes the CAN transceiver 13 (i.e., a monitor), the subordinate computer 12 (i.e., a first controller), and the main computer 16 (i.e., a second controller). The CAN transceiver 13 monitors whether data flows on the CAN bus 6 (i.e., an in-vehicle network) provided in the vehicle. The subordinate computer 12 is activated from a sleep state by the CAN transceiver 13 and then receives a data frame (i.e., data) flowing on the CAN bus 6. The main computer 16 is activated from a sleep state by the subordinate computer 12; the main computer 16 then reads out a program from the SD 17 (i.e., a storage) which stores the program, develops the program into the main memory 18 (i.e., a memory), and executes the program developed in the main memory 18.

The vehicular apparatus 1 under a system sleep state transitions from the system sleep state into a waiting state when the subordinate computer 12 is activated from the sleep state by the CAN transceiver 13 (i.e., when a change of a vehicle state is detected). Here, the waiting state of the vehicular apparatus 1 waits to receive a data frame having a specified ID (i.e., a specified kind of data). The vehicular apparatus 1 under the waiting state then transitions from the waiting state into a preparing state when the data frame with the specified ID is received before a predetermined reception waiting time elapses. Here, the preparing state of the vehicular apparatus 1 waits for the ACC switch being turned on (i.e., waits to receive an activation manipulation) under the state where the main computer 16 is activated and has completed reading out a program from the SD 17 and developing the read program into the main memory 18 (i.e., under the state where the reading of the module is completed). The vehicular apparatus 1 under the preparing state then transitions from the preparing state into an executing state when the ACC switch is turned on before a predetermined manipulation waiting time elapses. Here, the executing state of the vehicular apparatus 1 executes the program developed in the main memory 18 using the main computer 16.

Thus, the preparation for providing a function is started based on a fact that data flows on an in-vehicle network, (i.e., based on, as a trigger, a change in a vehicle state according to the present embodiment). Such configuration can shorten significantly a period of time from when the ACC switch is turned on to when the provision of the function is started, i.e., an activation time of the vehicular apparatus 1 which the user feels practically, compared with the case where the vehicular apparatus 1 transitions to an executing state based on, as a trigger, a fact that the ACC switch is turned on.

The vehicular apparatus 1 determines the transition into an activated state based on only an ID of a data frame of CAN; this can determine whether to transition into the executing state promptly, as compared with the case of going so far as analyzing a data field.

The vehicular apparatus 1, which includes the display unit 20, provides own function by displaying a variety of information on the display unit 20. Here, the activation time from the ACC switch is turned on to when the vehicular apparatus 1 starts to provide the function can be easily recognized by a user. The user may feel it convenient if the activation time is short; the user may feel it dissatisfied if the activation time is long. As described, the vehicular apparatus 1 shortens such activation time significantly, therefore reducing a possibility that the user may feel it dissatisfied.

In addition, the embodiment permits the display unit 20 to display an image of an area behind the vehicle, for instance, promptly when the ACC switch is turned on. This configuration enhances the safety at the time of driving a vehicle to depart from a halt position.

The vehicular apparatus 1 basically allows only the CAN transceiver 13 to be always applied with electric currents, thereby reducing a possibility that the power consumption increases significantly.

The present disclosure is not limited to the embodiment mentioned above at all, and can be modified or expanded as needed within a scope of a subject matter.

The embodiment provides a monitor (i.e., CAN transceiver 13) and a first controller (i.e., subordinate computer 12) to be separate from each other. Alternatively, the first controller may be a computer containing the monitor. Such a computer, which performs a process to determine whether to receive a specified ID, need not be highly efficient; even if being always applied with electric currents, the computer can be suppressed from increasing significantly the power consumption. In addition, only the monitor may be always applied with electric currents like the embodiment.

The embodiment determines the transition of the states based on only the ID of the data frame of CAN, but the data field or other data may be additionally used for the determination. For example, suppose that the positions of doors can be specified from the data field. Such case can provide a configuration that starts to prepare an activation when the driver seat door is opened and fails to start to prepare an activation when the rear-seat door or the trunk is opened. Such configuration does not start to prepare an activation when the change of the vehicle state occurs which does not start to travel of the vehicle; this reduces the electric power consumption.

The change of the vehicle state is not limited to the ones the embodiment explained, but also may include a detection of another change.

The present disclosure, which is directed to the vehicular apparatus 1 providing a function visually, may be also directed to a vehicular apparatus that does not relate to users.

The storage may not include only the SD 17 but also another one such as a hard disk, flash memory.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A vehicular apparatus comprising:
a monitor that is always activated to monitor whether data flows on an in-vehicle network in a vehicle;
a first controller that is activated from a sleep state by the monitor, to receive the data flowing on the in-vehicle network; and
a second controller that is activated from a sleep state by the first controller, to read out a program from a storage storing the program, develop the program in a memory, and execute the program developed in the memory,
wherein:
the vehicular apparatus transitions, when the first controller is activated by the monitor, from a system sleep into a waiting state,
the system sleep state that causes the first controller and the second controller to be each under the sleep state,
the waiting state that waits to receive a predetermined specified kind of data;
the vehicular apparatus transitions, when not receiving the specified kind of data before a predetermined reception waiting time elapses under the waiting state, from the waiting state into the system sleep state;
the vehicular apparatus transitions, when receiving the specified kind of data before the reception waiting time elapses under the waiting state, from the waiting state to a preparing state,
the preparing state that waits to receive an activation manipulation on condition that the second controller being activated has completed reading out the program and developing the program in the memory;
the vehicular apparatus transitions, when not receiving the activation manipulation before a manipulation waiting time elapses under the preparing state, from the preparing state into the waiting state; and
the vehicular apparatus transitions, when receiving the activation manipulation before the manipulation waiting time elapses under the preparing state, from the preparing state into an executing state,
the executing state that executes the program developed in the memory with the second controller.

2. The vehicular apparatus according to claim 1, wherein:
the in-vehicle network is CAN; and
the specified kind of data is an identifier of a data frame of CAN.

3. The vehicular apparatus according to claim 1, further comprising:
a display unit that displays information.
